(19) United States
(12) Patent Application Publication
(10) Pub. No.: US 2008/0029717 A1
(43) Pub. Date: Feb. 7, 2008

(54) EXTREME ULTRAVIOLET LIGHT SOURCE DEVICE AND METHOD OF GENERATING EXTREME ULTRAVIOLET RADIATION

(75) Inventor: Takahiro SHIRAI, Gotenba-shi (JP)

Correspondence Address: ROBERTS, MLOTKOWSKI & HOBBES, P. O. BOX 10064, MCLEAN, VA, 22102-8064, US

(73) Assignee: USHIODENKI KABUSHIKI KAISHA, Tokyo (JP)

(21) Appl. No.: 11/832,707

(22) Filed: Aug. 2, 2007

(30) Foreign Application Priority Data
Aug. 2, 2006 (JP) 2006-210813

(51) Int. Cl. G01J 3/10; G01J 11/00

(52) U.S. Cl. 250/504 R; 356/51

(57) ABSTRACT

Extreme ultraviolet light source device in which an EUV radiation fuel is introduced into a chamber, and high-voltage pulsed voltage from a high-voltage generator is applied between first and second main discharge electrodes, thereby producing a high-temperature plasma from discharge gas between the main discharge electrodes; EVU radiation with a wavelength of 13.5 nm is emitted. Of the EVU radiation emitted, the EUV radiation on the optical axis of the EUV collector mirror passes through a through-hole in the foil trap and through a through hole in the central support of the collector mirror, is reflected away from the optical axis by a reflector, and enters an EUV monitor. On the basis of EUV intensity signals input to the EUV monitor, a controller adjusts the power supplied from the high-voltage generator so that the EUV intensity is steady.

### BACKGROUND OF THE INVENTION

1. Field of the Invention

This invention relates to an extreme ultraviolet light source device that generates extreme ultraviolet radiation. In particular, it concerns a light source device for producing extreme ultraviolet radiation and the placement of measuring equipment to monitor the intensity of the extreme ultraviolet radiation.

2. Description of Related Art

With the micro-miniaturization and higher integration of semiconductor integrated circuits, there are demands for improved resolution in projection lithography equipment used in manufacturing integrated circuits. Lithography light source wavelengths have gotten shorter, and light source devices for producing extreme ultraviolet radiation (hereafter EUV light source device) that emit extreme ultraviolet (hereafter EUV) radiation with wavelengths from 13 to 14 nm, and particularly, the wavelength of 13.5 nm, has been developed as a next-generation semiconductor lithography light source to follow excimer laser equipment to meet these demands.

A number of methods of generating EUV radiation are known in EUV light source devices; one of these is a method in which high-temperature plasma is generated by heating and excitation of an EUV radiation fuel and extracting the EUV radiation emitted by the plasma.

EUV light source devices using this method can be roughly divided, by the type of high-temperature plasma production, into LPP (laser-produced plasma) type EUV light source devices and DPP (discharge-produced plasma) type EUV light source devices.

LPP-type EUV light source devices produce a high-temperature plasma by means of laser irradiation. DPP-type EUV light source device produces a high-density, high-temperature plasma by means of electrical current drive.

DPP-type EUV light source devices use such discharge types as the Z-pinch type, the capillary discharge type, the plasma focus type, and the hollow cathode trigger Z-pinch type.

Compared with LPP-type EUV light source devices, DPP-type EUV light source devices have the advantages of smaller size and lower power consumption in the light source system, and expectations for its practical use are great.

A radiation fuel that radiates 13.5 nm EUV radiation—that is, for example decavalent Xe (xenon) ion as a high-temperature plasma raw material for generation of EUV—is known in both these types of EUV light source devices, but Li (lithium) and Sn (tin) ions have been noted as a high-temperature plasma raw material that yields a greater radiation intensity.

For example, Sn has a conversion efficiency, which is the ratio of 13.5 nm wavelength EUV light radiation intensity to the input energy for generating high-temperature plasma, several times greater than that of Xe, and is seen as a leading contender as the radiation fuel for high-output EUV light sources. As indicated in Japanese Pre-Grant Patent Report 2004-279246 and corresponding U.S. Pat. No. 6,984,941, for example, EUV light sources that use tin compounds in gaseous form (such as stannane gas: SnH₄) as the raw material to supply Sn, as the EUV radiation fuel, to the discharge portion are being developed.

An example of the constitution of a DPP-type EUV light source device is shown in FIG. 7.

As shown in FIG. 7, the DPP-type EUV light source device has a chamber 1 that is a discharge vessel. Within the chamber 1 there are, for example, a ring-shaped first main discharge electrode 3a (cathode) and a second main discharge electrode 3b (anode) that surround a ring-shaped insulator 3c and constitute the discharge portion 9.

The first discharge electrode 3a and the second discharge electrode 3b are made of a high-melting-point metal, such as tungsten, molybdenum, or tantalum. The insulator 3c is made of a material such as silicon nitride, aluminum nitride, or diamond. Here, the chamber 1 and the second main discharge electrode 3b are grounded.

The ring-shaped first main discharge electrode 3a, second main discharge electrode 3b, and insulator 3c have through holes, and they are positioned with their through holes on roughly the same axis. When power is supplied between the first main discharge electrode 3a and the second main discharge electrode 3b and discharge is generated, as described below, the EUV radiation fuel is heated and excited and a high-temperature plasma P is generated within the through holes or in the vicinity of the through holes.

The supply of power to the discharge portion 9 is from a high-voltage generator 13 that is connected to the first main discharge electrode 3a and the second main discharge electrode 3b. The high-voltage generator 13 applies pulsed power with a short pulse width between the first main discharge electrode 3a and the second main discharge electrode 3b, which constitute the load, by way of a magnetic pulse compression circuit that comprises a capacitor and a magnetic switch.

Now, there are numerous other examples of the constitution of DPP-type EUV light source devices other than that shown in FIG. 7; see, e.g., “Recent Status and Future of EUV (Extreme Ultraviolet) Light Source Research,” J. Plasma Fusion Res., Vol. 79 No. 3, P219-260, March 2003, in that regard.

On the first main discharge electrode 3a side of the chamber 1, there is a discharge gas introduction port 2 that is connected to a gas supply unit 7 that supplies a discharge gas that includes the EUV radiation fuel. The EUV radiation fuel is supplied to the chamber 1 by way of the discharge gas introduction port 2.

On the second main discharge electrode 3b side of the chamber 1, there is a gas exhaust port 4 that is connected to an exhaust unit 8 that regulates the pressure in the discharge portion 9 and exhausts the chamber.

There is also an EUV collector mirror 6 on the second main discharge electrode 3b side of the chamber 1. The EUV collector mirror 6 comprises, for example, multiple mirrors in the shape of ellipsoids of revolution or paraboloids of revolution with differing radii nested on the same axis so that the focal point matches the axis of revolution (optical axis).

These mirrors are made of a smooth base material, such as nickel (Ni), with the reflecting surface of the concave mirror having a very smooth coating of a metal such as ruthenium (Ru), molybdenum (Mo), or rhodium (Rh). The mirrors are able to reflect incident EUV light well at angles of 0° to 25° from the reflective surface.

The EUV radiation emitted from high-temperature plasma P generated by heating and excitation in the discharge portion 9 is reflected and collected by the EUV collector mirror 6 and emitted to the outside from the EUV radiation extractor of the chamber 1. Now, the position in which the EUV radiation reflected by the EUV collector mirror 6 is collected is called the focal point.

Further, there is a foil trap 5 located between the discharge portion 9 and the EUV collector mirror 6. The foil trap 5 acts to prevent debris arising from Sn or other radiation fuel or from metal (perhaps from an electrode) spattered by the high-temperature plasma from moving toward the EUV collector mirror 6.

The foil trap, as shown in FIG. 8, comprises inner and outer concentric rings 5a, 5b, and multiple thin plates 5c that are positioned in the manner of spokes that are supported at both ends by the two rings 5a, 5b. By finely dividing the space, the plates 5c raise the pressure of the space and reduce the kinetic energy of debris. Much of the debris with lowered kinetic energy is captured by the plates 5c and the rings 5a, 5b of the foil trap 5. As seen from the perspective of the high-temperature plasma P, on the other hand, only the thickness of the plates is visible aside from the two rings, and almost all the EUV radiation passes through.

Returning to FIG. 7, an EUV light source device controller 14 controls the high-voltage generator 13, the gas supply unit 7, and the gas exhaust unit 8 on the basis of such things as EUV operation commands from a lithography controller (not illustrated).

For example, when the controller 14 receives EUV operation commands from the lithography controller (not illustrated), it controls the gas supply unit 7 and supplies a raw material gas that includes the EUV radiation fuel to the chamber 1. Further, on the basis of pressure data from a pressure monitor (not illustrated) mounted in the chamber 1, it controls the amount of raw material gas supplied by the gas supply unit 7 and the amount exhausted by the gas exhaust unit 8 so that the discharge portion 9 will have the specified pressure. Then, by controlling the high-voltage generator 13, it supplies power between the first main discharge electrode 3a and the second main discharge electrode 3b and generates a high-temperature plasma P that emits EUV radiation.

The operation of the EUV light source device is as follows.

(1) Discharge gas that includes the EUV radiation fuel is introduced into the chamber 1, which is the discharge vessel, from the discharge gas supply unit 7 by way of a gas introduction port 2 on the first main discharge electrode 3a side of the chamber 1.

(2) The discharge gas is, for example, stannane (SnH₄), and the introduced SnH₄ flows to the chamber 1 side through the passage formed by the first discharge electrode 3a, the second main discharge electrode 3b, and the insulator 3c of the discharge portion 9; it arrives at the gas exhaust port 4 and is exhausted from the gas exhaust unit 8.

(3) Here, the pressure of the discharge portion 9 is regulated between 1 and 20 Pa. This pressure regulation is performed as follows, for example. First, the controller 14 receives pressure data output by a pressure monitor (not illustrated) mounted in the chamber 1. On the basis of the pressure data received, the controller 14 controls the gas supply unit 7 and the gas exhaust unit 8 and adjusts the amount of SnH₄ supplied to the chamber 1 and the amount exhausted, thereby regulating the pressure in the discharge portion 9 to the specified pressure.

(4) When the discharge gas flows through the passage formed by the ring-shaped first main discharge electrode 3a, second main discharge electrode 3b, and insulator 3c, a high-voltage pulsed voltage of roughly +20 kV to −20 kV from the high-voltage generator 13 is applied between the second main discharge electrode 3b and the first main discharge electrode 3a. As a result, a creeping discharge is generated on the surface of the insulator 3c and actually causes a short-circuit condition between the first main discharge electrode 3a and the second main discharge electrode 3b; a large, pulsed current flows between the first main discharge electrode 3a and the second main discharge electrode 3b. Then, Joule heating due to the pinch effect causes the generation of high-temperature plasma P from the discharge gas in the high-temperature plasma portion between the ring-shaped first and second main discharge electrodes 3a, 3b, and EUV radiation with a wavelength of 13.5 nm is radiated from that plasma.

(5) The emitted EUV radiation is reflected by the EUV collector mirror 6 and collected, then emitted to the illuminating equipment, which is lithography equipment of which illustration is omitted, by the EUV radiation extractor 10.

The EUV optical monitor 11 (hereafter EUV monitor) detects incoming EUV light, and EUV radiation intensity signals are output from EUV monitor equipment 12 to the controller 14. On the basis of the EUV intensity signals, the controller 14 regulates the power supplied to the discharge portion 9 from the high-voltage generator 13 so that the EUV intensity will be steady.

Variation in the intensity of the EUV radiation emitted from the high-temperature plasma P is linked to variation in the intensity of illumination on the exposure surface of the lithography equipment, and can influence the precision of exposure.

Accordingly, an EUV monitor 11 to measure the intensity of EUV radiation can be located in the vessel of the EUV light source device, as described above.

The EUV monitor 11 basically comprises a photodiode and a filter that passes 13.5 nm EUV radiation; the input EUV intensity signal is sent to EUV monitor equipment 12 and output from the EUV monitor equipment 12 to the controller 14. On the basis of the input EUV intensity signals, the controller 14 regulates the power supplied to the discharge portion 9 from the high-voltage generator 13 on the basis of variations in the relative intensity of the EUV radiation emitted from the high-density, high-temperature plasma P so that the intensity of the EUV radiation will remain steady. Specifically, when the EUV intensity measured by the EUV monitor decreases, the voltage supplied to the discharge portion 9 from the high-voltage generator 13 is increased, and when the EUV intensity increases, the power supplied to the discharge portion 9 is decreased.

Conventionally, the EUV monitor has been arranged to receive a component of light that does not enter the EUV collector mirror 6.

Specifically, as shown in FIG. 7, it is located on the light collector mirror of the foil trap 5 to avoid the effects of debris, and it receives an optical component that passes through the foil trap 5 that does not enter the EUV collector mirror 6. By using a component that does not enter the EUV collector mirror 6, it is possible to measure the intensity of EUV radiation without reducing efficiency of use of the EUV radiation.

However, using the method described above, it is necessary to spread the opening of the foil trap 5 wider than the reception range of the EUV collector mirror 6, in order to collect EUV radiation for measurement. However, as described above, the foil trap 5 increases pressure by narrowly dividing the space in which it is located, and acts to reduce the kinetic energy of debris; if the opening is widened, it is much harder to increase the pressure, and that effect is diminished.

To heighten the effect of the foil trap 5, it is desirable that its opening be as small as possible, down to the same size as the input range of the EUV collector mirror 6.

Further, in the method described above, the EUV radiation entering the EUV monitor 11 has a broad angle of divergence with respect to the optical axis that connects the high-temperature plasma P and the focal point of the EUV collector mirror 6. However, the greater the angle of divergence from the optical axis, the weaker the intensity of the radiation will be from the high-temperature plasma P, and so it is necessary to use an expensive monitor with high sensitivity, which increases the cost of the equipment.

Further, the method of making a through hole in the EUV collector mirror 6 and collecting a portion of the radiation that enters the EUV collector mirror 6 can be considered as another method of collecting EUV radiation for measurement. If that were done, there would be no need to enlarge the opening of the foil trap 5. However, in that case, there would be a loss of the EVU radiation that should really be used for lithography, and so the efficiency of use of the light would drop and the intensity of illumination of the exposure surface would be reduced.

### SUMMARY OF THE INVENTION

This invention was made in light of the situation described above. Thus, a primary purpose of this invention is to enable the measurement of EVU radiation without reducing the effect of the foil trap by enlarging the opening of the foil trap, and without reducing the efficiency of use of EUV radiation by making a through hole in the EUV collector mirror.

The problems described above are resolved as follows in accordance with this invention.

(1) Of the EVU radiation that is emitted from the high-temperature plasma and enters the collector mirror, light that is not reflected by the reflective surface of the collector mirror and is not used for lithography, for example, EUV radiation on the optical axis of the collector mirror or EUV radiation that enters within a specified angle relative to the optical axis of the collector mirror and cannot be reflected and collected, is made to enter the EUV monitor and the intensity of the EVU radiation is measured.

In DPP-type EUV light source devices, while it depends on the design conditions of the collector mirror, generally EVU radiation from the high-temperature plasma that is radiated at an angle within 0° to 5° or 0° to 10° of the optical axis that connects the high-temperature plasma with the focal point of the EUV collector mirror does enter within the collector mirror but cannot be reflected and collected by the reflective surface, and is not used in lithography.

Accordingly, so that EUV radiation that has not been reflected by the reflective surface will not come to the focal point, it is actively obstructed by placing an obstruction, such as a support member for the foil trap or the EUV collector mirror, on the optical axis between the discharge portion and the extractor in the vessel of the EUV light source device.

Then, a through hole of the appropriate diameter (from several hundred μm to several mm) is formed in the obstruction on the optical axis, and the uncondensed light on the optical axis that passes through the through hole is collected and caused to enter the EUV monitor, and the intensity of the EUV radiation is measured.

(2) In (1) above, the EUV monitor can be placed on the optical axis so that the light that passes through the through hole enters the EUV monitor directly. Alternatively, a reflector can be placed on the optical axis so that the EVU radiation reflected by the reflector enters the EUV monitor.

(3) In (1) and (2) above, a film thickness monitor can be placed in the vessel to correct the output of the EUV monitor.

In other words, in the event that the discharge gas is solidified by the discharge or depositions otherwise arise from the gas, the depositions can accumulate on the reflective surface of the reflector placed in the path of the incident radiation of the monitor or on the light-receiving surface of the EUV monitor, and the sensitivity of the EUV monitor will be reduced.

Therefore, a film thickness monitor is also placed in the chamber to monitor the thickness of the depositions that have contaminated the light-receiving surface of the EUV monitor or the surface of the reflector; based on the EUV reflectance (or transmittance) relative to that of a thickness of depositions measured beforehand, the intensity of the EVU radiation measured by the EUV monitor is corrected.

The following effects can be achieved with this invention.

(1) Of the EVU radiation that is emitted from the high-temperature plasma and enters the collector mirror, light that is not reflected by the reflective surface of the collector mirror and cannot be used in lithography is made to enter the EUV monitor. Thus, measurement can be performed with EUV radiation that was not to be used for lithography, and the efficiency of light use is not reduced.

(2) Of the EUV radiation that enters the collector mirror, EUV radiation that is not reflected by the reflective surface of the collector mirror and cannot be used in lithography and that enters the collector mirror on the optical axis or within a specified angle of the optical axis is used, and so there is no need to enlarge the opening of the foil trap; the opening can be the same size as, or narrower than, the input range of the EUV collector mirror and the effect of the foil trap is not impaired.

(3) Light that enters the collector mirror on the optical axis or within a specified angle of the optical axis has the strongest intensity, and so it is possible to use an inexpensive EUV monitor with low sensitivity. Further, that EUV radiation can be measured even after being reflected by a mirror.

(4) Although a through hole is made an obstruction on the optical axis, its diameter is small, there is a pressure increase within the hole, and it has the same effect as the foil trap. Accordingly, it is possible to suppress contamination of the EUV monitor or the reflector by debris.

(5) Even if the discharge gas is a gas that generates depositions that contaminate the surface of the EUV monitor's detector or of the reflector and adhere to the surface of the EUV light monitor's detector or of the reflector, by installing a film thickness monitor and measuring the thickness of the depositions, it is possible to detect the EUV intensity measured by the EUV monitor on the basis of the reflectance (transmittance) of the EVU radiation with respect to the film thickness, and to measure the intensity of the EVU radiation with good accuracy.

### BRIEF DESCRIPTION OF THE DRAWINGS

FIG. 1 is a diagram showing a first embodiment of this invention.

FIG. 2 is a diagram showing the foil trap used in this invention.

FIG. 3 is a diagram showing an outline of the constitution of the EUV collector mirror of this invention.

FIG. 4 is a diagram showing an alternate form of the first embodiment.

FIG. 5 is a diagram showing a second embodiment of this invention.

FIG. 6 is a diagram showing a third embodiment of this invention.

FIG. 7 is a diagram showing an example of the constitution of conventional DPP-type EUV light source device.

FIG. 8 is a diagram showing an example of embodiment of the conventional foil trap.

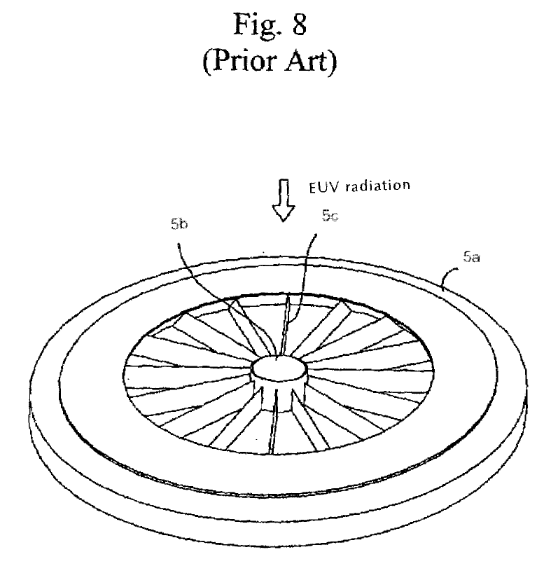

### DETAILED DESCRIPTION OF THE INVENTION

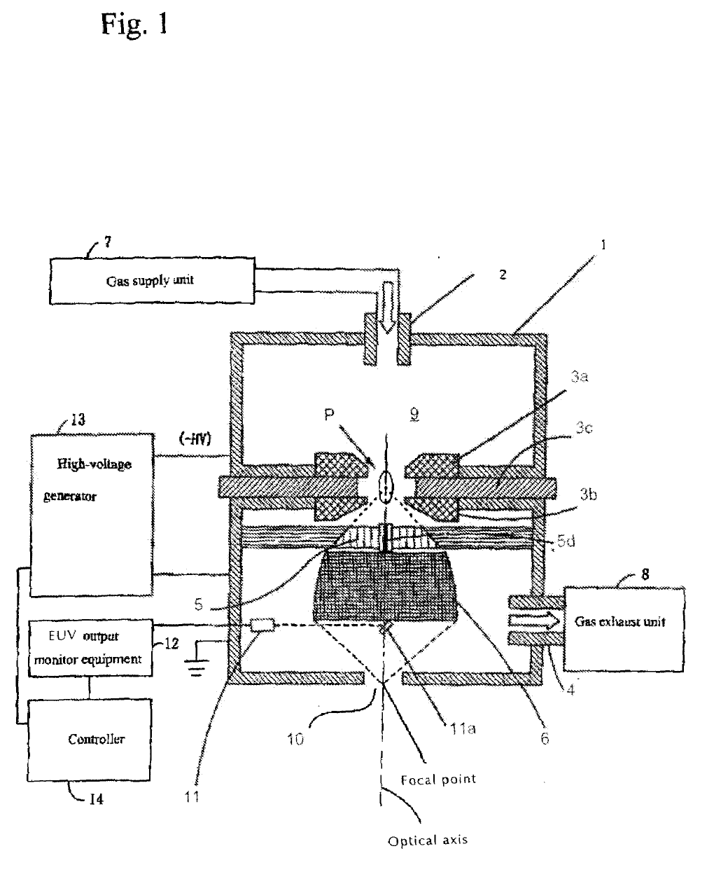

FIG. 1 is a diagram showing the first embodiment of this invention's EUV light source device having an EUV monitor.

Now, the following explanation of this embodiment refers to EUV radiation on the optical axis that connects the high-temperature plasma and the focal point as light that enters the collector mirror but that enters the EUV monitor without being reflected by the reflective surface of the collector mirror. However, that does not mean the EUV radiation has to be strictly on the optical axis. As long as EUV radiation enters the collector mirror but is not reflected by the reflective surface, it can be used as EUV radiation made to enter the EUV monitor, even if it is not EUV radiation on the optical axis.

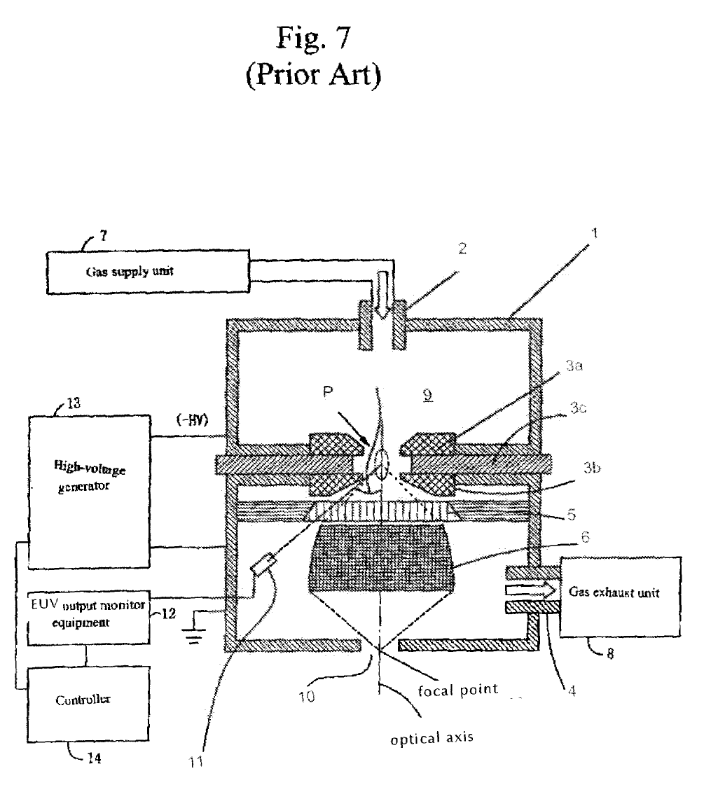

Like FIG. 7 described above, FIG. 1 shows a DPP-type EUV light source device; and parts in FIG. 1 that are the same as in FIG. 7 are labeled with the same reference characters.

As with the equipment shown in FIG. 7, discharge gas that includes an EUV discharge fuel enters the chamber 1, which is a discharge vessel, from a discharge gas supply unit 7, by way of a gas introduction port 2 on the first main discharge electrode 3a side. The discharge gas is, for example, stannane (SnH₄), and the SnH₄ that is introduced flows in the chamber 1 side through the passage formed by the first main discharge electrode 3a, the second main discharge electrode 3b, and the insulator 3c of the discharge portion 9; it reaches the gas exhaust port 4 and is exhausted from the gas exhaust unit 8.

With the discharge gas flowing through the passage formed by the ring-shaped first main discharge electrode 3a, second main discharge electrode 3b, and insulator 3c, a pulsed high-voltage from the high-voltage generator 13 is applied between the second main discharge electrode 3b and the first main discharge electrode 3a, and a large, pulsed current flows between the first main discharge electrode 3a and the second main discharge electrode 3b. Then, because of Joule heating from the pinch effect, a high-temperature plasma P is generated from the discharge gas between the first and second main discharge electrodes 3a, 3b, and EVU radiation with a wavelength of 13.5 nm is emitted from the plasma.

A foil trap 5 is located between the discharge portion 9 and the EUV collector mirror 6; it acts to prevent debris arising from Sn or other radiation fuel or from metal (perhaps from an electrode) spattered by the high-temperature plasma from moving toward the EUV collector mirror 6.

The radiated EVU radiation is reflected by the EUV collector mirror 6, and emitted from an extractor 10 to the illumination portion, which is a lithography optical system (not shown).

A reflector 11a that reflects EVU radiation on the optical axis away from the optical axis is located on the output side of the EUV collector mirror 6; of the EVU radiation emitted from the high-temperature plasma P, the EUV radiation on the optical axis of the EUV collector mirror 6 is reflected and enters an EUV monitor 11.

The EUV monitor 11 monitors the incident EVU radiation, and EUV intensity signals are output from an EUV monitor equipment 12 to a controller 14. On the basis of the EUV intensity signals that are input, the controller 14 adjusts the power supplied to the discharge portion 9 from the high-voltage generator 13 so that the EUV intensity remains steady.

In the past, structures, such as supports that support the inner ring 5b of the foil trap 5 or the mirrors of the EUV collector mirror 6, have been located on the optical axis between the discharge portion 9 and the reflector 11a, and the EUV radiation on the optical axis that is not reflected by the EUV collector mirror 6 has been prevented from reaching the focal point.

However, in this invention, the EUV radiation on the optical axis that enters within the EUV collector mirror 6 but is not reflected by the reflective surfaces is used to measure the intensity of the EVU radiation. Therefore, a through hole 5d that allows passage of EVU radiation is formed in the support or other structure located on the optical axis, as shown in FIG. 1.

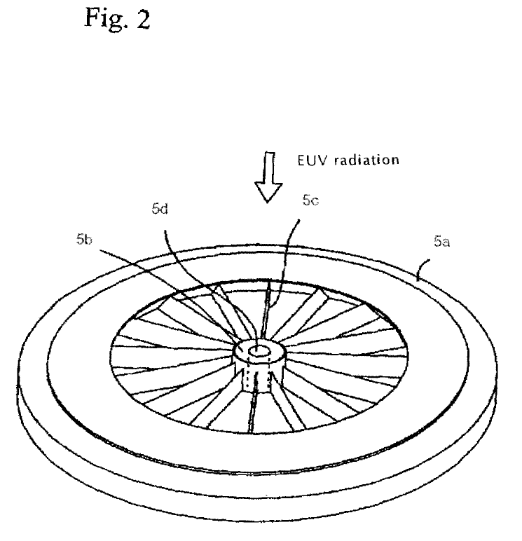

For example, the foil trap 5 used in this invention is shown in FIG. 2. As shown in that figure, there is a through hole 5d in the inner ring 5b of the foil trap 5, which is on the optical axis.

The diameter of the through hole 5d should be set appropriately so that EUV radiation can be obtained for the EUV monitor 11 to measure the intensity. Because the intensity of radiation on the optical axis is strong, however, the diameter of the through hole 5d can be as small as several hundred μm to several mm.

It is possible that, when there is a through hole 5d in the inner ring 5b of the foil trap 5, debris from the electrodes could pass through the through hole 5d and reach the collector mirror 6, but because the diameter of the through hole 5d is small, as stated above, it is thought that conductance within the through hole 5d will be high, the internal pressure will be high, the kinetic energy of the debris passing through will be reduced, and debris will have almost no effect on the reflecting mirrors of the collector mirror 6.

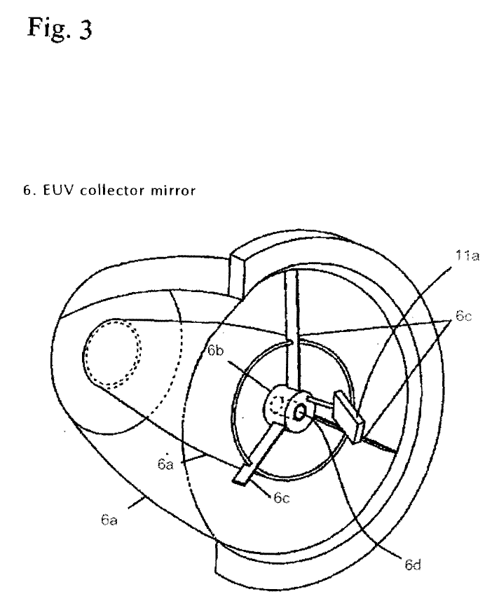

Further, an outline of the constitution of the EUV collector mirror of this invention is shown in FIG. 3. This Figure is an oblique view with a part of the EUV collector mirror 6 cut away, and is a diagram as seen from the EUV output side.

As shown in this figure, the EUV collector mirror 6 has multiple mirrors 6a (there are two in this example, but there may be five to seven) in the form of ellipsoids of revolution or paraboloids of revolution of which a cross section taken in a plain that includes the central axis is an ellipse or parabola (this central axis is called the “central axis of revolution” hereafter).

These mirrors 6a are nested with their axes of revolution on the same axis so that their focal point positions are approximately the same; the central support 6b is placed in position on the central axis of revolution, with radial hub-shaped supports 6c attached to the central support 6b. Each mirror 6a (the inner surface of which is a mirrored surface of an ellipsoid of revolution or a paraboloid of revolution) is supported by these hub-shaped supports 6c.

The central support 6b and hub-shaped supports 6c are positioned so as to obstruct the EVU radiation entering the collector mirror 6 as little as possible.

As shown in this figure, there is a through hole 6d in the central support 6b on the optical axis, the same as the foil trap 5 of FIG. 2.

Next, a reflector 11a that reflects (turns back) the EVU radiation on the optical axis away from the optical axis is located on the optical axis that connects the high-temperature plasma P generated in the discharge portion 9 and the focal point of the EUV collector mirror 6, and on the output side of the EUV collector mirror 6. Specifically, the reflector 11a is attached to the central support 6b, as shown in FIG. 3.

Of the EVU radiation emitted from the high-temperature plasma P, the light on the optical axis of the EUV collector mirror 6 passes through the through hole 5d of the inner ring 5b of the foil trap 5 and continues to enter the through hole 6d of the central support 6b.

When the EVU radiation that enters the through hole 6d of the central support 6b passes through the through hole 6d, it is reflected away from the optical axis by the reflector 11a mounted on the output side of the central support, and enters the EUV monitor 11.

The reflector 11a is a reflecting mirror formed by vapor deposition of many layers of molybdenum (Mo) and silicon (Si) on its surface. The multiple layers are designed, with consideration to the angle of reflection, so that the central wavelength of the reflected EUV radiation will be 13.5 nm.

The reflector 11a also fills the role of an obstruction that prevents EUV radiation on the optical axis from entering the focal point, and so no unnecessary EUV radiation on the optical axis, which has entered the collector mirror 6 but has not been reflected by the reflective surfaces, enters the focal point. Now, the angle at which the EVU radiation is turned back by the reflector 11a need not be a right angle as shown in the figure.

Further, there is no need to use EVU radiation that has passed outside the EUV collector mirror 6, and so the opening in the foil trap 5 can be the same size as the inputrange of the EUV collector mirror 6.

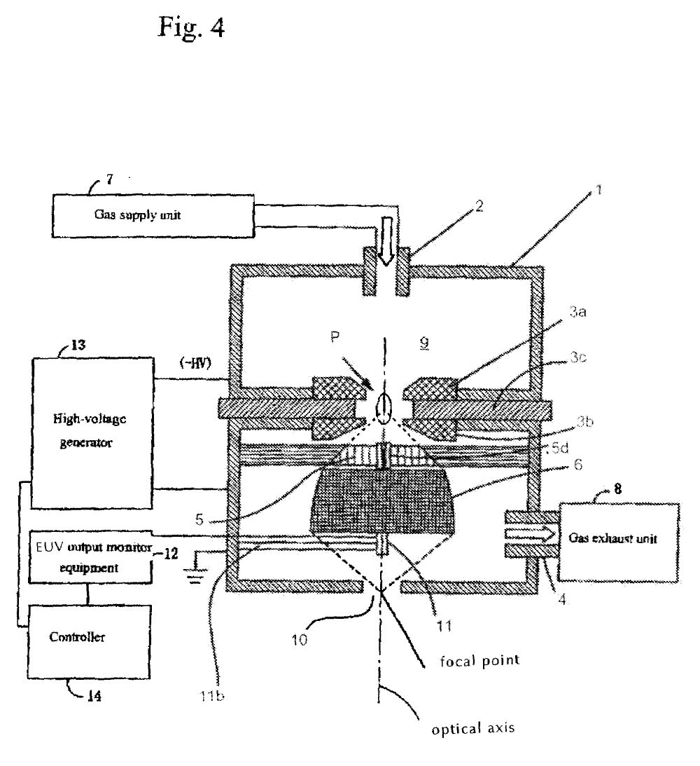

FIG. 4 shows an alternate form of the first embodiment.

In the first embodiment, the EVU radiation is turned back by the reflector 11a and enters the EUV monitor 11, but this example is one in which the EUV monitor is directly positioned in the place of the reflector 11a; otherwise the constitution is the same as that of the first embodiment.

In this case, there is a through hole through which EVU radiation passes on a structure on the optical axis between the discharge portion 9 and the EUV monitor 11, the same as described above.

With such a constitution, it is possible to monitor the EVU radiation in the same way as described above, and the EUV monitor 11 fills the role of an obstruction that prevents light on the optical axis from entering the focal point.

Now, in this embodiment, the support member 11b that supports the EUV monitor 11 located on the optical axis and the wiring connected to the EUV monitor 11 cut across the output side of the EUV collector mirror 6. For that reason, the support member and wiring can be positioned along the hub-shaped support 6c that supports the mirrors of the EUV collector mirror 6 shown in FIG. 3, so that the light emitted from the EUV collector mirror 6 is not obstructed.

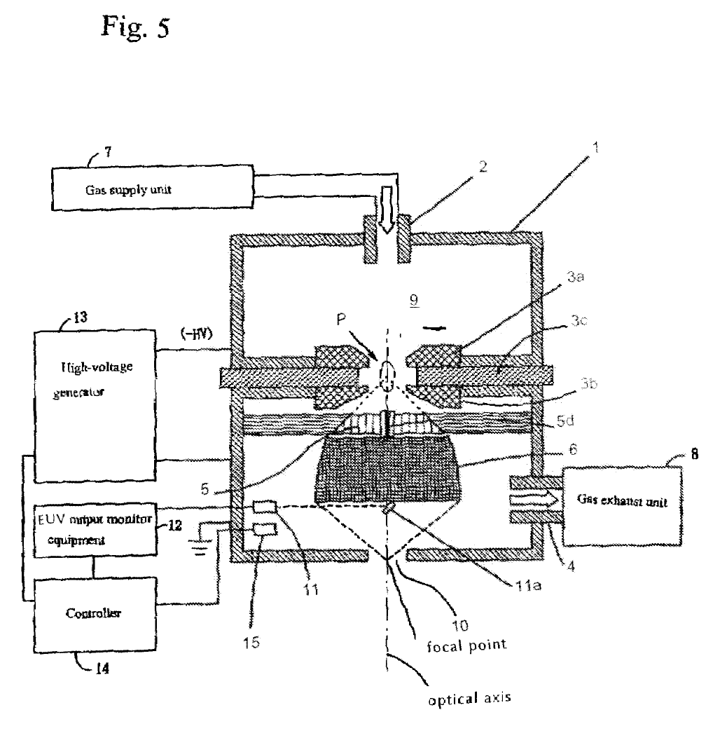

The second embodiment of this invention is shown in FIG. 5.

The difference from the first embodiment is that a film thickness monitor 15 is located in the chamber 1 so as to correct the EUV intensity data from the EUV monitor by means of the measurement results from the film thickness monitor 15; otherwise its constitution and operation are the same as those of the first embodiment described above.

The film thickness monitor 15 measures the thickness of attached debris on the basis of changes in the frequency of a crystal oscillator that are caused by the depositions.

For example, if stannane (SnH₄) is used as the discharge gas in order to use Sn as the EUV generation fuel, tin and tin compounds will be generated by the discharge. Almost all of this is caught by the foil trap 5 or exhausted, but it is possible for a part of it to accumulate on and adhere to the detector (the incidence surface) of the EUV monitor 11 or the surface of the reflector 11a mirror if one is used.

When debris adheres to the reflector 11a or the detector of the EUV monitor 11, the volume of light received by the EUV monitor is reduced to that extent, and so even though EVU radiation of the same intensity is radiated from the high-temperature plasma P, the EUV intensity signals output from the EUV monitor 11 grow smaller. For that reason, the controller 14 raises the voltage supplied to the discharge portion.

To prevent this, in this embodiment, a film thickness monitor is placed in the chamber to measure the film thickness of the accumulated debris adhered to the EUV monitor 11 or the reflector 11a and to output the data signals to the controller 14.

Further, the reflectance (transmittance) of EVU radiation relative to the thickness of the deposition is measured experimentally in advance, and the data is stored in the controller 14.

The controller 14 determines the reflectance (transmittance) relative to the EVU radiation of the EUV monitor 11 or the reflector 11a, on the basis of the reflectance (transmittance) of EVU radiation relative to the thickness of contaminated debris stored as stated above and the input film thickness data of deposition in the chamber 1, such as on the reflector 11a or the EUV monitor 11, and then corrects the EUV intensity data from the EUV monitor 11.

For example, in the event that the transmittance based on the film thickness is 50% and there are depositions of the same thickness on both the reflector 11a and the EUV monitor 11, the actual EUV intensity would be four times the value of EUV intensity from the EUV monitor 11.

In this way, even in the event that a discharge gas that is made solid (produces depositions) by discharge, it is possible to measure the intensity of the EVU radiation by installing a film thickness monitor 15 in the chamber 1.

In the event that correction becomes difficult because the film continues to accumulate and the film thickness that accumulates on the film thickness monitor 15 exceeds the thickness that was determined in advance, the EUV monitor 11 and the reflector 11a are replaced. Further, when the EUV monitor 11 and the reflector 11a are replaced, there is a strong possibility that there will be a similar thick deposition of debris on the EUV collector mirror 6, and so it is best to replace the entire EUV collector mirror 6.

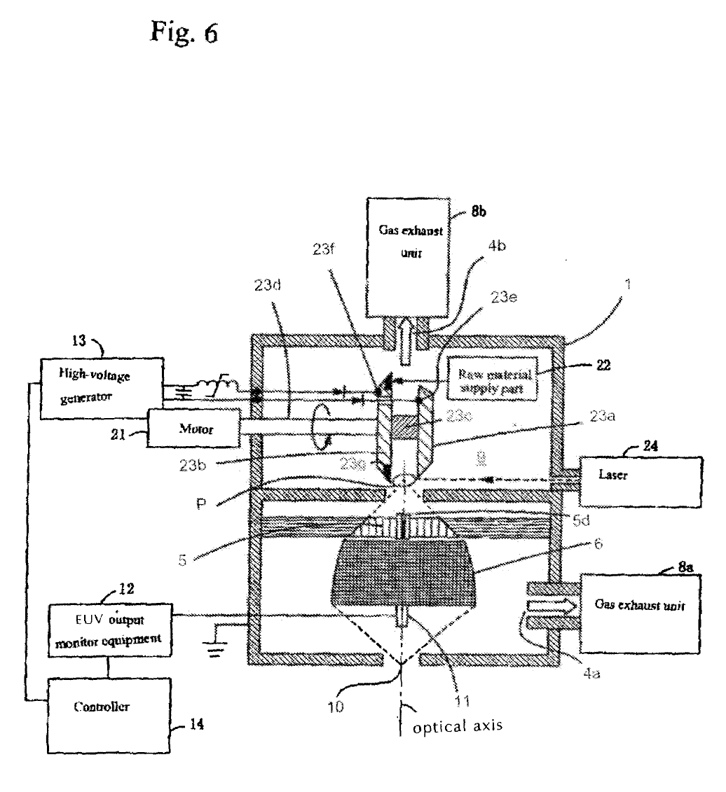

FIG. 6 is the third embodiment of this invention, which is an example of the constitution in the event that electrode disks that rotate are used in the discharge portion 9.

Now, in this figure, as in the embodiments described above, there is a optical axis that connects the high-temperature plasma P and the focal point of the EUV collector mirror 6, and an EUV monitor 11 is mounted on the output side of the EUV collector mirror 6, but a reflector 11a can be located as shown in FIG. 1 so that the EUV monitor 11 receives EUV radiation reflected by the reflector 11a.

The constitution of the EUV light source device of this embodiment is basically the same as that of the first embodiment described above, with the exception of the structure of the electrodes etc. in the discharge portion 9. As stated hereafter, however, the Sn or Li raw material that is the EUV generation fuel is liquefied by heating and supplied in that form. For that reason, there is no gas supply unit 7 or gas introduction port 2 as shown in the first embodiment described above; rather, there are first and second gas exhaust ports 4a, 4b and first and second gas exhaust units 8a, 8b. Further, there is a laser 24 to gasify the Sn or Li raw material.

The structure of the discharge portion 9 in the third embodiment shown in FIG. 6 is explained next.

The structure of the discharge portion 9 has a first main discharge electrode 23a made of a disk-shaped metal and a second main discharge electrode 23b similarly made of a disk-shaped metal placed to sandwich an insulator 23c. The center of the first main discharge electrode 23a and the center of the second main discharge electrode 23b are located on approximately the same axis, and the first main discharge electrode 23a and the second main discharge electrode 23b are fixed in positions separated by a gap the thickness of the insulator 23c. Here, the diameter of the second main discharge electrode 23b is larger than the diameter of the first main discharge electrode 23a. Further, the thickness of the insulator 23c, which is the gap separating the first main discharge electrode 23a and the second main discharge electrode 23b, is from about 1 mm to about 10 mm.

A rotary shaft 23d of a motor 21 is attached to the second main discharge electrode 23b. The rotary shaft 23d is attached to approximately the center of the second main discharge electrode 23b so that the center of the first main discharge electrode 23a and the center of the second main discharge electrode 23b are positioned approximately on the axis of the rotary shaft 23d.

The rotary shaft 23d is introduced into the chamber 1 by way of, for example, a mechanical seal. The mechanical seal allows the rotary shaft 23d to rotate while maintaining the reduced-pressure atmosphere of the chamber 1.

A first wiper 23e, comprising a carbon brush, for example, and a second wiper 23f are installed on one face of the second main discharge electrode 23b. The second wiper 23f is electrically connected to the second main discharge electrode 23b.

The first wiper 23e, on the other hand, is electrically connected to the first main discharge electrode 23a, through a through hole that penetrates the second main discharge electrode 23b, for example. Now, an insulation mechanism (not shown) is constituted so that there is no electrical breakdown between the second main discharge electrode 23b and the first wiper 23e that is electrically connected to the first main discharge electrode 23a.

The first wiper 23e and the second wiper 23f are electrical contacts that maintain an electrical connection while wiping; they are connected to the high-voltage generator 13. The high-voltage generator 13 supplies pulsed power between the first main discharge electrode 23a and the second main discharge electrode 23b by way of the first wiper 23e and the second wiper 23f.

In other words, even though the motor 21 rotates and the first main discharge electrode 23a and the second main discharge electrode 23b are rotated, pulsed power from the high-voltage generator 13 is applied between the first main discharge electrode 23a and the second main discharge electrode 23b by way of the first wiper 23e and the second wiper 23f.

Now, another structure can be used as long as it enables electrical connection between the first main discharge electrode 23a, the second main discharge electrode, and the high-voltage generator 13.

The high-voltage generator 13 applies pulsed power with a short pulse width between the first main discharge electrode 23a and the second main discharge electrode 23b, which constitute the load, by way of a magnetic pulse compression circuit that comprises a capacitor and a magnetic switch. The wiring from the high-voltage generator 13 to the first wiper 23e and the second wiper 23f is by way of insulated current introduction terminals, illustration of which has been omitted.

The current introduction terminals are mounted in the chamber 1, and allow an electrical connection from the high-voltage generator 13 to the first wiper 23e and the second wiper 23f while maintaining the reduced-pressure atmosphere of the chamber 1.

The peripheries of the first main discharge electrode 23a and the second main discharge electrode 23b, which are disk-shaped metal pieces, are constituted in an edge shape. As described hereafter, when power from the high-voltage generator 13 is applied between the first main discharge electrode 23a and the second main discharge electrode 23b, a discharge is generated between the edge-shaped portions of the two electrodes.

The electrodes reach a high temperature because of the high-temperature plasma, and so the first main discharge electrode 23a and the second main discharge electrode 23b are made of a metal with a high melting point, such as tungsten, molybdenum, or tantalum. Further, the insulator 23c is made of silicon nitride, aluminum nitride, or diamond, for example.

A groove 23g is made in the periphery of the second main discharge electrode 23b, and solid Sn or solid Li, which is the EUV generation fuel, is supplied to this groove 23g. For example, the raw material supply portion 22 liquidizes the raw material Sn or Li, which is the EUV generation fuel, by heating, and supplies it to the groove 23g of the second main discharge electrode 23b.

In the event that a liquefied raw material Sn or Li is supplied by the raw material supply portion 22, the liquefied raw material Sn or Li can be supplied by the raw material supply portion 22 in the form of droplets, for example, by rotating the EUV light source device as shown in FIG. 6 90° counter-clockwise, so that the raw material supply portion is on the left and the EVU radiation extraction portion is on the right.

Alternatively, the raw material supply unit can be constituted to supply solid Sn or Li to the groove 23g of the second main discharge electrode 23b periodically.

The motor 21 rotates in only one direction, and by means of operation of the motor 21, the rotary shaft 23d rotates and the second main discharge electrode 23b and the first main discharge electrode 23a attached to the rotary shaft 23d rotate in that direction. The Sn or Li placed in or supplied to the groove 23g of the second main discharge electrode 23b moves.

In the chamber 1, on the other hand, there is a laser 24 that generates a laser beam irradiating the Sn or Li moving to the EUV collector mirror 6 side. By way of an unillustrated laser beam aperture and a laser beam condensing means installed in the chamber 1, the laser beam from the laser 24 is condensed and irradiates the Sn or Li moving to the EUV collector mirror 6 side.

As stated above, the diameter of the second main discharge electrode 23b is larger than the diameter of the first main discharge electrode 23a. Therefore the laser beam can easily be aligned to pass by the side of the first main discharge electrode 23a and irradiate the groove 23b of the second main discharge electrode 23b.

The emission of EVU radiation from the electrodes happens as follows.

The laser beam from the laser 24 irradiates the Sn or Li. The Sn or Li irradiated by the laser beam is gasified between the first main discharge electrode 23a and the second main discharge electrode 23b, and a portion is ionized. Under these conditions, pulsed power from the high-voltage generator 13 with a voltage of about +20 kV to −20 kV is applied between the first and second main discharge electrodes 23a, 23b, at which time a discharge is generated between the edge-shaped portions on the periphery of the first main discharge electrode 23a and the second main discharge electrode 23b.

At that time, a large, pulsed current flows through the ionized portion of the gasified Sn or Li between the first main discharge electrode 23a and the second main discharge electrode 23b. Then, by means of Joule heating, a high-temperature plasma P is formed from the gasified Sn or Li in the vicinity between the two electrodes, and EVU radiation with a wavelength of 13.5 nm is emitted from the high-temperature plasma P.

The radiation passes through the foil trap 5, enters the EUV collector mirror 6, and is collected on the EUV extractor 10 that is the focal point; from the EVU extractor 10 it is emitted outside the EUV light source device.

An EUV monitor 11 is located on the optical axis on the radiation side of the EUV collector mirror 6, and as in the embodiments described above, there is a through hole through which EVU radiation passes on a structure on the optical axis between the discharge portion and EUV monitor 11. Of the EVU radiation emitted from the high-temperature plasma P, light on the optical axis of the EUV collector mirror 6 enters the EUV monitor 11.

The EUV monitor 11 monitors the incident EVU radiation, and an EUV intensity signal is output from the EUV monitor equipment 12 to the controller 14. On the basis of the input EUV light intensity signal, the controller 14 regulates the power supplied by the high-voltage generator 13 so that the EUV intensity is steady.

What is claimed is:

1. Extreme ultraviolet light source device having
a vessel,
an extreme ultraviolet radiation fuel supply means for supplying an extreme ultraviolet radiation fuel to the vessel,
a heating and excitation means for heating and exciting the extreme ultraviolet radiation fuel and generating a high-temperature plasma,
a collector mirror having a reflective surface that reflects and collects the extreme ultraviolet radiation emitted from the high-temperature plasma,
an extreme ultraviolet radiation extractor formed in the vessel that extracts the collected light, and an exhaust means that exhausts the vessel, and
an optical monitor that measures the intensity of the extreme ultraviolet radiation positioned for receiving a portion of the extreme ultraviolet radiation that enters the collector mirror from the high-temperature plasma that is not reflected by the reflective surface of the collector mirror.

2. Extreme ultraviolet light source device as claimed in claim 1, further comprising a reflector that reflects the radiation that is not reflected by the reflective surface of the collector mirror to the optical monitor that measures the intensity of the extreme ultraviolet radiation.

3. Extreme ultraviolet light source device as claimed in claim 2, wherein a film thickness monitor is mounted in the vessel to correct the output of the optical monitor.

4. Extreme ultraviolet light source device as claimed in claim 1, wherein a film thickness monitor is mounted in the vessel to correct the output of the optical monitor.

5. Method of generating extreme ultra violet radiation, comprising the steps of:
introducing an extreme ultraviolet radiation fuel into a chamber,
pulsing a high voltage from a high-voltage generator and applying the pulsed high-voltage between first and second main discharge electrodes, thereby producing a high-temperature plasma from discharge gas between the main discharge electrodes so as to emit extreme ultraviolet radiation,
causing the extreme ultraviolet radiation emitted on a optical axis of an extreme ultraviolet radiation collector mirror to pass through a through-hole in a foil trap and through a through hole in a central support of the collector mirror, and reflecting it away from the optical axis by a reflector,
directing the light reflected by the reflector into an extreme ultraviolet monitor, and
using a controller to adjust the power supplied from the high-voltage generator so that the extreme ultraviolet intensity is steady on the basis of the extreme ultraviolet intensity detected by the extreme ultraviolet monitor.
